(19) United States
(12) Patent Application Publication
(10) Pub. No.: US 2005/0056152 A1
(43) Pub. Date: Mar. 17, 2005

(54) Solid fermentation starter having improved storage stability

(76) Inventor: Hideto Ishida, Chuo-ku (JP)

Correspondence Address: FOLEY AND LARDNER;SUITE 500, 3000 K STREET NW, WASHINGTON, DC, 20007, US

(21) Appl. No.: 10/499,905

(22) PCT Filed: Dec. 20, 2002
(86) PCT No.: PCT/JP02/13398

(30) Foreign Application Priority Data
Dec. 28, 2001 (JP) 2001-401337
Sep. 9, 2002 (JP) 2002-263234

(51) Int. Cl. A23L 1/00

(52) U.S. Cl. 99/275

(57) ABSTRACT

The present invention is to provide a starter to be used for producing fermented foods and fermented beverages with a simple means, as a fermentation starter excellent in storage properties and stability. A fermentation starter excellent in storage properties and stability is produced by treating the surface of a solid starter comprising cereal starch materials such as oats and the like containing fermentation microorganisms with dry-heat treatment such as roasting for a short time. According to the method, microorganisms on the surface are sterilized by forming a layer treated with dry-heat treatment such as roasting on the surface of a solid fermentation starter, and the invasion of external microorganisms is prevented with the layer, and further, internal yeast and other bacilli can be stored with maintaining their activity by being protected by the treated layer.

### TECHNICAL FIELD

The present invention relates to a fermentation starter having storage stability, particularly to a solid fermentation starter having improved storage stability used for producing various fermented foods and fermented beverages, and a use thereof.

### BACKGROUND ART

Historically, in the production of various fermented foods or fermented beverages, in many cases, in order to promote fermentation smoothly and evenly, microorganisms which are to be inocula are fermented with a part of fermentation materials and the like beforehand to prepare a fermentation starter wherein activation and growth phase of microorganisms are combined, and to make use of it.

For instance, in the production of breads, the following method is conducted: before fermentation, a part of flour material is mixed with yeast beforehand and fermented sufficiently to produce dough, to which all remaining flour is added, mixed and fermented. Moreover, when producing dairy products such as yogurt, an inoculum is cultured on a culture medium such as skim milk beforehand to prepare a fermentation starter.

Further, a fermentation starter is also used for the production of fermented alcoholic beverages. For instance, as for the production of “sake”, sake yeast is added to koji mold with steamed rice, steamed rice or the like, and fermented to prepare a starter called “moto” before the preparation and fermentation of sake materials.

Recently, for the production of beer-like alcoholic beverages, a method to use moto which is used for the production of sake is disclosed (Japanese Laid-Open Patent Application No. 7-000168). In the method, the following production method of low-malt beer is adopted: moto (starter) is added to the saccharified liquid that is obtained by adding a kind of koji, wherein white varieties of genes Aspergillus or Rhizopus is propagated to rice, barley and/or corn, to malt and starch materials in order to prepare mash.

Generally, in fermentation industry, it is a usual procedure to preculture necessary microorganisms, which are used as dough for enlarged culture gradually, and a fermentation starter is used for producing various fermented foods or fermented beverages as mentioned above.

Such fermentation starter is usually prepared each time as a preliminary step of the main fermentation process. Since it has to be prepared basically for each fermentation batch, it is lead to the prolongation of production time of fermented foods or fermented beverages.

Recently, for such convenience, a method to store a starter prepared beforehand by refrigeration and the like has been developed, and the problems of homogenization of fermentation starter or shortening of production time have been solved. However, the methods are still some problems such as problems of refrigeration equipment or problems of resistance to refrigeration (low temperature) of microorganisms and the like.

The object of the present invention is to provide a fermentation starter having storage stability, particularly to provide a starter to be used for producing fermented foods and fermented beverages with a practical means as a fermentation starter excellent in storage properties and stability.

As a result of keen study to solve the above-mentioned objects, the present inventors found that by using a solid starter comprising starch material like cereals such as oats and the like, a fermentation starter excellent in storage properties and stability can be produced by treating the surface of the solid starter with dry-heat treatment such as roasting for a short time. Thus, the present invention has been completed. In other words, according to the present invention, by forming a layer treated with dry-heat treatment such as roasting on the surface of the solid yeast starter, it will be possible to prevent the invasion of microorganisms from external world as well as to sterilize microorganisms on the surface, and further it will be also possible to store the internal yeast and other bacilli by maintaining their activation being protected by the treated layer. It is also possible to attach bacilli having mashing ability such as koji mold (Aspergillus oryzae), mold of genus Rhizopus, mold of genus Mucor and the like to the surface thereafter. The solid fermentation starter of the present invention has a merit that can be prepared by a simple treatment such as roasting, and further, to be used as a fermentation starter excellent in storage properties and stability. In the fermentation starter of the present invention, microorganisms having acid generating ability such as lactic acid bacteria as well as microorganisms having alcohol fermenting ability such as yeast can coexist. Further, depending on fermentation material, microorganisms having mashing ability such as starch or enzymes having mashing activity can be further contained in such starter. The fermentation starter of the present invention can be used particularly conveniently in the production method for fermented alcohol beverages.

### DISCLOSURE OF THE INVENTION

The present invention relates to: a solid fermentation starter having improved storage stability wherein the surface of the solid fermentation starter prepared by comprising fermentation microorganisms contained in starch material is treated with dry-heat treatment (“1”); the solid fermentation starter having improved storage stability according to “1”, wherein the dry-heat treatment to the surface of the solid fermentation starter is a roasting treatment (“2”); the solid fermentation starter having improved storage stability according to “1” or “2”, wherein microorganisms to be comprised in the fermentation starter are microorganisms having alcohol fermenting ability (“3”); the solid fermentation starter having improved storage stability according to “3”, wherein the microorganisms having alcohol fermenting ability are yeast (“4”); the solid fermentation starter having improved storage stability according to “1” or “2”, wherein the microorganisms to be comprised in the solid fermentation starter are microorganisms having alcohol fermenting ability and microorganisms having acid generating ability (“5”); the solid fermentation starter having improved storage stability according to “5”, wherein the microorganisms having alcohol fermenting ability are yeast, and the microorganisms having acid generating ability are lactic acid bacteria (“6”); the solid fermentation starter having improved storage stability according to any one of “3” to “6”, wherein microorganisms having mashing ability or enzymes having mashing activity are further contained in the solid fermentation starter (“7”); the solid fermentation starter having improved storage stability according to “7”, wherein the microorganisms having mashing ability are molds of koji, genus Rhizopus, genus Mucor, or mixed molds of two or more of them (“8”); the solid fermentation starter having improved storage stability according to any one of “1” to “8”, wherein the starch material is a starch material prepared from cereal (“9”); the solid fermentation starter having improved storage stability according to “9”, wherein the starch material prepared from cereal comprises sprouted or unsprouted oats material (“10”); the solid fermentation starter having improved storage ability according to any one of “2” to “10”, wherein the surface is solidified by roasting and the whole is maintained in form of bread (“11”); a solid fermentation supplementary starter wherein the surface and the inside of a solid fermentation starter prepared by adding at least microorganisms having acid generating ability to starch material is sterilized by heating to stop the activity of the microorganisms (“12”).

The present invention further relates to: a production method of fermented foods or fermented beverages, wherein the solid fermentation starter having improved storage stability and/or the solid fermentation supplementary starter according to any one of “1” to “12” is used as a solid fermentation starter and/or solid fermentation supplementary starter for producing fermented foods or fermented beverages (“13”); a production method of fermented alcohol beverages wherein the solid fermentation starter having improved storage properties and/or the solid fermentation supplementary starter according to any one of “1” to “12” is used as a solid fermentation starter and/or solid fermentation supplementary starter for producing fermented alcohol beverages (“14”); the production method of fermented alcohol beverages according to “14”, wherein the fermented alcohol beverage is a fermented alcohol beverage with malt (“15”); the production method of fermented alcohol beverages according to “14”, wherein the fermented alcohol beverage is a sweetened fermented alcohol beverage with sweet and sour flavor (“16”); the production method of fermented alcohol beverages according to “14”, wherein the fermented alcohol beverage is a Japanese sweet rice wine-like fermented alcohol beverage (“17”).

### BEST MODE OF CARRYING OUT THE INVENTION

The present invention relates to form a solid fermentation starter by inoculating a starch material with fermentation microorganisms, and to treat the surface of such solid fermentation starter with dry-heat treatment to obtain a solid fermentation starter excellent in storage properties and stability. As for the dry-heat treatment of the present invention, roasting treatment is advantageously used. As for the starch material used as a material of the present invention, although it is preferable to use fermentation material used for the production of yeast fermented foods or fermented beverages, cereal fermentation materials such as oats can be advantageously used. For instance, when it is used as a fermentation starter for the production of fermented alcohol beverages such as malt fermented alcohol beverages, it is preferable to use sprouted or unsprouted oats materials and the like as starch material. As for the fermentation microorganisms to be comprised in the solid fermentation starter, microorganisms having alcohol fermenting ability such as yeast are used. It is also possible to make microorganisms having acid generating ability such as lactic acid bacteria coexist in a solid fermentation starter as fermentation microorganisms, to improve further the storage properties of a solid fermentation starter by a product of the microorganisms.

Further, depending on material of fermented foods or fermented beverages using fermenting starter, it is possible to make microorganisms having mashing ability such as koji mold, mold of genus Rhizopus, mold of genus Mucor and the like or enzymes having mashing activity coexisted, in addition to fermenting starter to make easier to use starch materials of fermentation microorganisms in fermentation, and to promote fermentation. As for the enzymes having mashing activity, diastatic enzymes of malts or other diastatic enzymes can be used.

One of the examples of producing the fermentation starter of the present invention is described as follows: first, starch materials such as wheat powder and the like are prepared, the starch materials are kneaded with water and the like; useful microorganism such as yeast, lactic acid bacteria and the like are added, and the mixture is maintained in a semisolid condition until microflora of the microorganisms is formed. In the meantime, acidification mashing and the like of mixed materials, as well as proliferation and activation of microorganisms occur. The produced starter in a semisolid condition is fractionated in appropriate size, and the surface is roasted for a short time under a condition does not affect the activity of internal microflora. The surface of the starter in a semisolid condition is dried and solidified by roasting, and the whole surface is maintained in a form of bread. The fermentation starter of the present invention can be stored in a stabilized condition, and can be carved out when used.

As for the solid fermentation supplementary starter of the present invention, the fermented products produced by microorganisms for fermentation can be used by annihilating inexistent fermentation microorganisms by heating the solid fermentation starter, in a condition that the function of such fermentation microorganisms for fermentation is stopped. Such method of using the solid fermentation supplementary starter, especially when lactic acid bacteria are comprised as fermentation microorganisms, can be advantageously used when such fermentation products are used with fermentation starter, since sufficient amount of lactic acid, fermentation promoting materials such as nutrient salts, vitamins, amino acids and the like, and saprophyte inhibitor and the like are accumulated therein.

Another example of using the fermentation starter of the present invention to produce the mash by using sprouted or unsprouted oats materials as starch material is described in the following.

The fermentation starter wherein sprouted or unsprouted oats materials are used as starch material can be most advantageously used as a fermentation starter to form mash by using sprouted or unsprouted oats materials to the wort (including partial wort) prepared by using sprouted oats material (malt material) as material.

In such case, as for the wort (including partial wort) wherein sprouted or unsprouted oats material subjected to form mash is used, the mashed liquid wherein other cereal materials or their extract or syrup are added as an adjunct to sprouted or unsprouted oats materials, and mashed by using hydrolase in the wort (various amylases, proteases, and the like) or hydrolase externally added, or the liquid wherein koji mold with steamed rice, barley koji, corn koji wherein white koji, genus Rhizopus, or genus Mucor is propagated is used as a source of hydrolase, or the liquid wherein the above-mentioned are appropriately arranged can be used. Obviously, hop or various herbs can further be added.

The fermentation starter of the present invention used for forming fermented mash can be prepared by adding other starch materials, sugar, or fruits, herbs to the oats and its processed goods to be mashed in some cases. As for the microorganisms, they can be prepared by adding microorganisms having lactic acid fermenting ability, or microorganisms having hydrolyzing ability of starch and protein, besides yeast having alcohol fermenting ability. Microorganisms are inoculated and proliferated to a certain level, and then the fermentation starter treatment processes of the present invention are conducted to add promotion activity of fermentation and stability to stabilize. Microorganisms having alcohol fermenting ability are microorganisms of yeast group, which can be exemplified by genus Pichia, genus Hansenulla and the like, besides genus Saccharomyces.

Typical microorganisms having lactic acid fermenting ability are lactic acid bacteria, which can be exemplified by microorganisms of genus Lactobacillus, genus Lactococcus, or genus Streptcoccus. Microorganisms having hydrolyzing ability (hydrolyzing ability of starch and protein) can be exemplified by the ones of genus Aspergillus, genus Rhizopus, genus Mucor, or some of yeast group having hydrolyzing ability. These can be useful in mashing oats used as starch materials, and are to support the use of starch in the fermentation of lactic acid bacteria or yeast bacteria used as fermentation starter.

Mashing of starch materials can also be conducted using diastatic enzyme of malt.

The fermentation starter of the present invention can be used as a fermentation starter when producing various fermented foods or fermented beverages, and it can be most advantageously used as a fermentation starter for producing fermented alcohol beverages. Examples of such fermented alcohol beverages include fermented alcohol beverages with malt such as beer or low malt beer, or alcohol beverages with sweet and sour flavor, or Japanese sweet rice wine-like alcohol beverages.

It will be further described in detail with reference to the case wherein the fermentation starter when the present invention is used for producing fermented alcohol beverages.

As for an example, the fermented alcohol beverages wherein sprouted or unsprouted oats materials are used as starch materials, first of all, wort (including partial wort) wherein sprouted or unsprouted materials are used as fermentation materials are prepared (hereinafter referred to as wort).

As for the wort, wort usually prepared in the production of beer or low malt beer can also be used. Further, in order to make an original taste, wort wherein malt or oats and other cereals or their extract, syrup are mashed using hydrolase in the wort (various amylases, proteases and the like) or hydrolase externally added, or wort wherein cereal materials wherein white koji, koji mold with steamed rice wherein molds of genus Rhizopus or genus Mucor are propagated, barley koji, corn koji and the like are mashed to oat as a source of hydrolase can also be used. As for the source of hydrolase, it can be prepared by combining the previously described methods such as malt, external enzyme, koji and the like accordingly. Moreover, fruit juice or fruit syrup can be added.

The fermentation starter of the present invention is added to the wort prepared as mentioned above. As for the fermentation starter, the solid fermentation starter having storage stability, wherein the raised products having sprouted or unsprouted oats materials as starch materials, which are raised by adding yeast and lactic acid bacteria, or further koji mold or malt depending on the case, is treated with dry-heat treatment of the present invention, is used. As for the time to add, it can be added after the termination of the mashing when mashing is to be completely finished as in the case of producing beer or low malt beer, or it can be added during the mashing process, and the mashing which is called simultaneous fermentation and the fermentation can be conducted in parallel when microorganisms having hydrolyzing ability are added to microflora of a fermentation starter and mashing of starch materials is conducted by its hydrolyzing ability. It is particularly preferable to add lactic acid bacteria to the fermentation starter of the present invention in order to add certainly the antibacterial activity and storage properties. It is also possible to add lactic acid depending on the case. In forming mash, mash or wort will be in a condition having improved resistance to saprophytes by the acidification by lactic acid generated by lactic acid bacteria, or by the activity of antibacterial substance in lactic acid bacteria culture depending on the case. The fermentation starter prepared in form of bread can be milled and added to form mash easily. Moreover, in the production of small amount, it is possible to produce with oats which are preservatives of the fermentation starter of the present invention, or the one wherein other starch is added to the oats (in bread form or bread itself).

The present invention will be further described in detail with reference to the examples, however, the technical scope of the present invention will not be limited to these examples.

[Preparation of Fermentation Starter]

### EXAMPLE 1

500 mg of lactic acid for brewing is dissolved in 135 g of warm water at 40° C., and added to 70 g of barley flour and 30 g of ordinary flour (strong flour) (or 100 g of total barley flour), 2 g of Saccharomyces cerevisiae (crushed beer yeast) is further added therein as yeast, and 10 g of dry oats koji wherein Rhizopus genus mold is propagated is added. After kneaded, it is maintained at 30-35° C. until it rises (for approximately 12 hours), and then, it was baked in an oven at approximately 200° C. until the surface get slightly brown.

### EXAMPLE 2

135 g of water at room temperature is added to 100 g of barley flour, and mixed. Lactobacillus (bulgaricus) is simultaneously added as lactic acid bacteria at a level of 10⁵, and approximately 2 ml of dry yeast and Saccharomyces cerevisiae (beer yeast) are added. After kneaded, the dough was rise after being stored at approximately 30° C. for approximately 12 hours with avoiding perspiration by being covered with plastic wrap. It is baked in an oven toaster (800 W sheathed heater) for 3 minutes to roast and solidify the surface. It is left to stand in a room for approximately 1 week to allow koji mold of genus Rhizopus, and genus Aspergullus to attach. 10% of the milled product is used instead of the bacilli which are to be added to reprepare the dough, and the surface is roasted and solidified. The fermentation starter is prepared by repeating such repreparations. The surface should be roasted and solidified in order to avoid internal microflora from being annihilated.

[Production of Fermented Alcohol Beverages by the Fermentation Starter of the Present Invention]

### EXAMPLE 3

130 g of malt extract (converted to dry goods) and 15 mg of hop extract are dissolved in warm water of 80° C. to obtain 1 L, and cooled-down to room temperature with a rid on in order to avoid microbial contamination. 400 g of milled products of the fermentation starter of Example 2 are added therein, and fermented at 25-30° C. for 3 days. Fermentation is sometimes prolonged for another 2 days at room temperature depending on the condition of fermentation. After the centrifugation of the supernatant of fermented liquid, carbon dioxide was injected to carbonate. By subjecting to a sensory examination, alcohol beverages with rich flavor were obtained.

### EXAMPLE 4

50 g of malted barley flour is added to 50 g of durum wheat flour, and mixed through a sieve. 80 ml of water, ½ teaspoon of sugar, and ½ teaspoon of dry yeast are added and kneaded well. It is stored in warm temperature being covered with plastic wrap for 3 hours. After rise, it is kneaded once and let be rise again. It is baked at 200° C. for 20 minutes and bread was obtained. The bread, 100 g of the fermentation starter of Example 2, and 50 g of fruit parts of dry dates are milled and mixed in electric blender, and water is added to the extent that solid parts are soaked, and allow to ferment (When effervescence of fermentation is insufficient, dry yeast is added according to need.). Fermented liquid was centrifuged and subjected to sensory examination, and a fermented alcohol beverage with sweet and sour flavor was obtained.

### EXAMPLE 5

Approximately 10% of milled fermentation starter of Example 2 is added and mixed with cooked rice, and subjected to fermentation at approximately 30° C. for 5 days. The exuding fermented liquid is collected and subjected to sensory examination, and a Japanese sweet rice wine-like fermented beverage is obtained.

### INDUSTRIAL APPLICABILITY

According to the present invention, a fermentation starter excellent in storage properties and stability can be produced by treating the surface of a solid starter comprising of starch materials like cereals such as oats and the like usually used for producing fermented foods and fermented beverages and the like with dry-heat treatment such as roasting for a short time. The solid fermentation starter of the present invention can be used without specific refrigeration equipment since it can be prepared by a simple surface treatment such as roasting, which would not cause problems concerning the resistance to refrigeration of microorganisms. It is further possible to prepare and provide a fermentation starter with a uniform quality constantly since the fermentation solid starter of the present invention can be a fermentation starter excellent in storage properties and stability. Therefore, it is possible to produce stable fermented products and to shorten the production time in the production of fermented foods or fermented beverages and the like by using the fermentation solid starter of the present invention.

1. A solid fermentation starter having improved storage stability wherein the surface of the solid fermentation starter prepared by comprising fermentation microorganisms contained in starch material is treated with dry-heat treatment.

2. The solid fermentation starter having improved storage stability according to claim 1, wherein the dry-heat treatment to the surface of the solid fermentation starter is a roasting treatment.

3. The solid fermentation starter having improved storage stability according to claim 1, wherein microorganisms to be comprised in the fermentation starter are microorganisms having alcohol fermenting ability.

4. The solid fermentation starter having improved storage stability according to claim 3, wherein the microorganisms having alcohol fermenting ability are yeast.

5. The solid fermentation starter having improved storage stability according to claim 1, wherein the microorganisms to be comprised in the solid fermentation starter are microorganisms having alcohol fermenting ability and microorganisms having acid generating ability.

6. The solid fermentation starter having improved storage stability according to claim 5, wherein the microorganisms having alcohol fermenting ability are yeast, and the microorganisms having acid generating ability are lactic acid bacteria.

7. The solid fermentation starter having improved storage stability according to claim 3, wherein microorganisms having mashing ability or enzymes having mashing activity are further contained in the solid fermentation starter.

8. The solid fermentation starter having improved storage stability according to claim 7, wherein the microorganisms having mashing ability are molds of koji, genus Rhizopus, genus Mucor, or mixed molds of two or more of them.

9. The solid fermentation starter having improved storage stability according to claim 1, wherein the starch material is a starch material prepared from cereal.

10. The solid fermentation starter having improved storage stability according to claim 9, wherein the starch material prepared from cereal comprises sprouted or unsprouted oats material.

11. The solid fermentation starter having improved storage ability according to claim 2, wherein the surface is solidified by roasting and the whole is maintained in form of bread.

12. A solid fermentation supplementary starter wherein the surface and the inside of a solid fermentation starter prepared by adding at least microorganisms having acid generating ability to starch material is sterilized by heating to stop the activity of the microorganisms.

13. A production method of fermented foods or fermented beverages, wherein the solid fermentation starter having improved storage stability and/or the solid fermentation supplementary starter according to claim 1 is used as a solid fermentation starter and/or solid fermentation supplementary starter for producing fermented foods or fermented beverages.

14. A production method of fermented alcohol beverages wherein the solid fermentation starter having improved storage properties and/or the solid fermentation supplementary starter according to claim 1 is used as a solid fermentation starter and/or solid fermentation supplementary starter for producing fermented alcohol beverages.

15. The production method of fermented alcohol beverages according to claim 14, wherein the fermented alcohol beverage is a fermented alcohol beverage with malt.

16. The production method of fermented alcohol beverages according to claim 14, wherein the fermented alcohol beverage is a sweetened fermented alcohol beverage with sweet and sour flavor.

17. The production method of fermented alcohol beverages according to claim 14, wherein the fermented alcohol beverage is a Japanese sweet rice wine-like fermented alcohol beverage.
